(19) United States
(12) Patent Application Publication
(10) Pub. No.: US 2014/0300235 A1
(43) Pub. Date: Oct. 9, 2014

(54) ROTOR OF MOTOR AND MOTOR COMPRISING ROTOR

(71) Applicant: Panasonic Corporation, Kadoma-shi, Osaka (JP)

(72) Inventors: Yuichi Yoshikawa, Osaka (JP); Takashi Ogawa, Osaka (JP)

(21) Appl. No.: 14/355,283

(22) PCT Filed: Oct. 26, 2012
(86) PCT No.: PCT/JP2012/006882

§ 371 Date: Apr. 30, 2014

(30) Foreign Application Priority Data
Nov. 1, 2011 (JP) 2011-240124

(51) Int. Cl. H02K 1/27

(52) U.S. Cl. CPC H02K 1/27
USPC 310/156.48

(57) ABSTRACT

A rotor of a motor comprises a plurality of magnetic-pole sections including: a plurality of slots which are formed inside of a rotor core; and permanent magnets, at least one of which is inserted into each of the plurality of slots; wherein each of the magnetic-pole sections is formed to correspond to the at least one permanent magnet; and wherein the rotor core includes hollow portions formed by cutting portions of the rotor core which portions are between the magnetic-pole sections which are adjacent in the circumferential direction of the rotor core and are different in polarity such that portions of circumferential end portions of the permanent magnet are exposed, and extending portions each of which is formed in a position corresponding to the hollow portions and extends radially outward from a center portion of the rotor core.

### TECHNICAL FIELD

The present invention relates to a rotor of a motor and a motor comprising the rotor. Particularly, the present invention relates to a rotor of a motor and a motor comprising the rotor, which are directed to attaining a higher efficiency of a brushless motor.

### BACKGROUND ART

As a brushless motor in which a rotor is provided with permanent magnets, there are a surface permanent magnet brushless motor (SPM motor) in which the permanent magnets are attached to the surface of the rotor and an interior permanent magnet brushless motor (IPM motor) in which the permanent magnets are inserted into slots of the rotor. Of these motors, since the IPM motor has a structure in which the permanent magnets are embedded in the rotor, it is possible to easily prevent the permanent magnets from being scattered due to the rotation of the rotor as compared to the SPM motor in which the permanent magnets are required to be bonded to the surface of the rotor. Therefore, high reliability is expected. In addition, in the IPM motor, the permanent magnets of a flat plate shape can be used. In other words, in the IPM motor, it is not necessary to form curved surfaces in the permanent magnets to allow the permanent magnets to be attached on the surface of the rotor, unlike the SPM motor. This can reduce material cost. Therefore, it is expected that high reliability and low cost can be attained by applying the IPM motor to an industrial servo motor such as a semiconductor control device.

However, since the IPM motor has a structure in which the plurality of permanent magnets are embedded in the rotor to form a plurality of magnet poles, magnetic flux may leak from an iron core portion (bridge portion) between the permanent magnets. If the magnetic flux leaks, magnet torque generated by the permanent magnets decreases. So, in the case of the IPM motor and the SPM motor which are of the same size, the torque constant of the IPM motor is smaller than the torque constant of the SPM motor. As a structure for solving such a problem, there is known a structure in which the bridge portion between the permanent magnets is cut to form a hollow portion (e.g., see Patent Literatures 1 to 3). By forming the hollow portion in the bridge portion between the permanent magnets, magnetic characteristics can be improved.
Patent Literature 1: Japanese-Laid Open Patent Application Publication No. 2011-4480
Patent Literature 2: Japanese-Laid Open Patent Application Publication No. 2010-246301
Patent Literature 3: Japanese-Laid Open Patent Application Publication No. 2005-328616

### SUMMARY OF THE INVENTION

### Technical Problem

High controllability is required for the servo motor to attain high positioning accuracy. Regarding this, the SPM motor can attain high controllability relatively easily because only the magnet torque generated by the permanent magnets is output as motor torque. For this reason, conventionally, the SPM motor is commonly used as the servo motor. By comparison, in the IPM motor, torque derived by superposing on the magnet torque, reluctance torque generated by suction and reaction between poles associated with a rotational magnetic field of the stator and magnetic poles of the permanent magnets of the rotor, is the motor torque. FIG. 10 is a graph showing a relationship between a current advance angle θ and motor torque T in a general IPM motor. As can be seen from FIG. 10, the magnet torque Tm is greatest when the current advance angle θ=0 degree, while reluctance torque Tr is greatest when the current advance angle θ=45 degrees. Therefore, between the SPM motor in which there is only magnet torque Tm component and there is no reluctance torque Tr component and the IPM motor in which the magnet torque Tm component and the reluctance torque Tr component are superposed, the current advance angle θ corresponding to the greatest motor torque T is different. Because of this, a general inverter used to drive the SPM motor and a general controller for driving the inverter are unable to properly drive the IPM motor.

Regarding this, in the structures disclosed in Patent Literature 1 and Patent Literature 3, the leakage of the magnetic flux can be surely prevented and the torque constant can be increased by forming the hollow portion in the bridge portion. However, the reluctance torque component increases, and hence the current advance angle corresponding to the greatest motor torque changes. Therefore, the IPM motor cannot be used in place of the SPM motor. That is, an inverter exclusive for the IPM motor and a controller for activating the inverter become necessary. This results in high cost. In the configuration disclosed in Patent Literature 2, the reluctance torque can be reduced while increasing the torque constant, but the reluctance torque cannot be adjusted. It is estimated that the reluctance torque which is optimal for the current advance angle is different depending on specification and use of the motor (reluctance torque=0 is not always best). Therefore, in the conventional configuration in which the reluctance torque cannot be adjusted, the reluctance torque which is optimal for the current advance angle cannot be generated.

The present invention is directed to solving the above described problem associated with the prior art, and an object of the present invention is to provide a rotor of a motor and a motor comprising the rotor, which can properly adjust reluctance torque while preventing a leakage of magnetic flux.

### Solution to Problem

According to an aspect of the present invention, there is provided a rotor of a motor comprising a plurality of magnetic-pole sections including: a plurality of slots which are formed inside of a rotor core such that the slots penetrate the rotor core in a rotational axis direction and are arranged in a circumferential direction of the rotor core; and permanent magnets, at least one of which is inserted into each of the plurality of slots; wherein each of the magnetic-pole sections is formed to correspond to the at least one permanent magnet; and wherein the rotor core includes hollow portions formed by cutting portions of the rotor core which portions are between the magnetic-pole sections which are adjacent in the circumferential direction of the rotor core and are different in polarity such that portions of circumferential end portions of the permanent magnets are exposed, and extending portions each of which is formed in a position corresponding to the hollow portions and extends radially outward from a center portion of the rotor core.

In accordance with this configuration, portions of the rotor core which are between the magnetic-pole sections which are formed by the permanent magnets and are different in polarity from each other, are cut to form the hollow portions such that the portions of the circumferential end portions of the permanent magnets are exposed. This makes it possible to prevent a situation in which the magnetic flux leaks through a rotor core portion (bridge portion) between the magnetic-pole sections. In addition, each of the extending portions is formed in a position corresponding to the hollow portions such that the extending portion extends radially outward from the center portion of the rotor core. In this structure, by adjusting permeability of q-axis (axis between the magnetic-pole sections) with respect to permeability of d-axis (center axis of the magnetic-pole section), the reluctance torque can be made smaller than that of the conventional general IPM motor. Thereby, the motor of the present invention can be actuated appropriately by a general inverter used to actuate the SPM motor and a general controller for actuating the general inverter. By suitably adjusting the length of the extending portion, the reluctance torque can be adjusted appropriately. Therefore, the reluctance torque can be adjusted appropriately while preventing the leakage of the magnetic flux.

The rotor core may be configured to include at least one first plate member and at least one second plate member which are stacked together; the first plate member may be provided with a plurality of openings into which the permanent magnets are inserted such that the openings are arranged in the circumferential direction of the rotor core, and each of the openings surrounds one magnetic-pole section formed by inserting two permanent magnets into the opening; the second plate member may include a plurality of magnet support portions provided in positions corresponding to the openings of the first plate member, respectively; each of the magnet support portions may include in a state in which the permanent magnets are inserted into the slots, an outer peripheral portion located radially outward relative to the permanent magnets, the center portion located radially inward relative to the permanent magnets, and a connecting portion provided in a position corresponding to a circumferential center region of the opening of the first plate member such that the connecting portion connects the outer peripheral portion and the center portion to each other; the hollow portions may be formed in positions corresponding to circumferential both end portions of the opening such that the outer peripheral portion of the second plate member and the center portion of the second plate member are apart from each other, in a state in which the permanent magnets are inserted; and each of the extending portions may be formed between adjacent magnet support portions formed in the second plate member such that the extending portion extends radially of the rotor core from the center portion. In accordance with this configuration, the first plate member provided with the openings each surrounding one magnetic-pole section makes it possible to prevent the permanent magnet inserted into the opening from being scattered. In addition, the second plate member provided with the hollow portions and the extending portions makes it possible to reduce the reluctance torque while preventing a leakage of magnetic flux. Therefore, by forming the rotor core by stacking together the first plate member and the second plate member, it becomes possible to easily construct the IPM motor which has high reliability, is manufactured at low cost, and is applicable to a general inverter, a general controller, etc.

A tip end of each of the extending portions may be located inward relative to a turning circle of the outer peripheral portion. This makes it possible to effectively reduce the reluctance torque.

The rotor core may be constructed in such a manner that one first plate member and one second plate member are alternately stacked together, or a set of a plurality of first plate members and a set of a plurality of second plate members are alternately stacked together. Thereby, the outer peripheral portion of the second plate member and the center portion of the second plate member are connected to each other via the first plate member as well as the connecting portion. Therefore, the whole rotor core can enhance its strength, and it becomes possible to more effectively prevent the permanent magnets (and outer peripheral portion) from being scattered due to the rotation.

Each of the openings may be configured such that a gap is formed between each of the circumferential both end portions of each of the permanent magnets and an inner wall of the opening, in a state in which the permanent magnets are inserted into the slots. Since the permanent magnet is provided with the gap between the rotor core and the inner wall of the opening, a flux barrier portion can be formed. In other words, since a magnetic resistance in the gap increases, it becomes possible to effectively prevent a leakage of the magnetic flux from the permanent magnets to outside.

According to another aspect of the present invention, a motor comprises the rotor of the motor having the above configuration.

In accordance with this configuration, by constructing the motor using the rotor which can reduce the reluctance torque while preventing a leakage of the magnetic flux, a general inverter, a general controller, etc., may be used even when this motor is used as a servo motor in place of the conventional SPM motor. As a result, high reliability and low cost can be achieved.

The above and further objects features, and advantages of the invention will more fully be apparent from the following detailed description with accompanying drawings.

### Advantageous Effects of the Invention

The present invention has been configured as described above, and has advantages that it is possible to adjust reluctance torque appropriately while preventing a leakage of magnetic flux.

### BRIEF DESCRIPTION OF THE DRAWINGS

FIG. 1 is a cross-sectional view showing an exemplary planar structure of a motor including a rotor of a motor according to an embodiment of the present invention.

FIG. 2 is a plan view showing a first plate member constituting the rotor of the motor of FIG. 1.

FIG. 3 is a partially enlarged perspective view of the first plate member of FIG. 2.

FIG. 4 is a plan view showing a second plate member constituting the rotor of the motor of FIG. 1.

FIG. 5 is a partially enlarged perspective view of the second plate member of FIG. 4.

FIG. 6 is a side view of a rotor core of the motor of FIG. 1, when viewed from a q-axis direction.

FIG. 7 is a graph showing a change in a torque constant corresponding to a length of an extending portion in a motor including a rotor in Example of the present invention, in comparison with a torque constant of a general IPM motor and a torque constant of a general SPM motor.

FIG. 8 is a graph showing a change in a salient-pole ratio (Lq/Ld) corresponding to the length of the extending portion in the motor including the rotor in Example of the present invention, in comparison with a salient-pole ratio of the general IPM motor and a salient-pole ratio of the general SPM motor.

FIG. 9 is a graph showing deviations of salient-pole ratios from the salient-pole ratio in a case where an extension ratio is 0.985 in the graph of Example of FIG. 8.

FIG. 10 is a graph showing a relationship between a current advance angle θ and motor torque T in a general IPM motor.

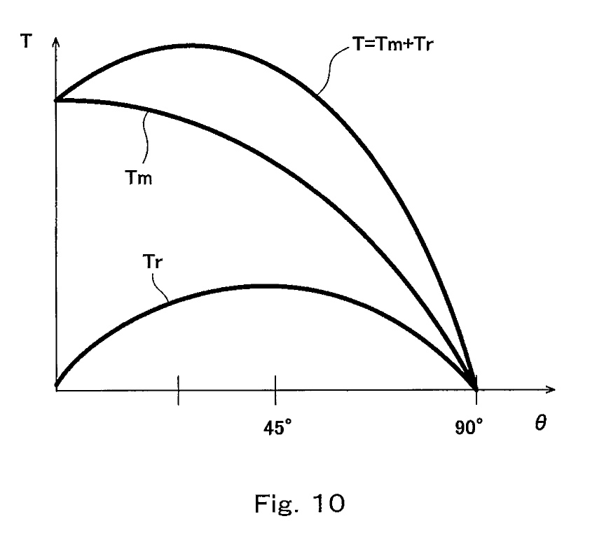

### DETAILED DESCRIPTION OF THE PREFERRED EMBODIMENTS

Hereinafter, an embodiment of the present invention will be described with reference to the drawings. Throughout the drawings, the same or corresponding components are designated by the same reference numerals and will not be described in repetition.

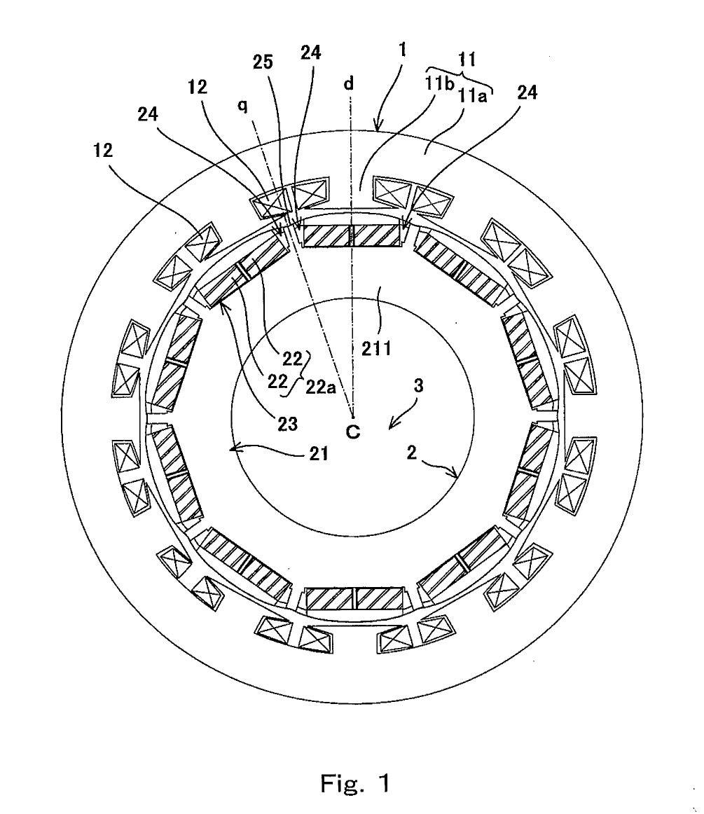

FIG. 1 is a cross-sectional view showing an exemplary planar structure of a motor including a rotor of a motor according to an embodiment of the present invention. FIG. 1 is a plan view of a stacked structure in which a second plate member 42 (described later) is stacked on a first plate member 41 (described later), when viewed from the second plate member 42 side. As shown in FIG. 1, a brushless motor (hereinafter will be simply referred to as a motor) according to the present embodiment includes a tubular stator 1 attached to an inner wall surface of an outer frame (not shown), and a tubular rotor 2 retained inward relative to the stator 1 such that the rotor 2 is rotatable with respect to the stator 1. The rotor 2 is provided with a hole 3 in a center portion thereof. A shaft structure (not shown) including a shaft which is a rotary shaft is mounted to the hole 3. In a state in which the shaft structure is inserted into the hole 3, the rotor 2 and the shaft structure are fastened to each other.

The stator 1 includes a stator core 11 including a tubular portion 11a of a tubular shape and a plurality of (twelve in the present embodiment) teeth 11b extending radially inward from an inner wall surface of the tubular portion 11a, and coils 12 wound around the teeth 11b, respectively. The rotor 2 includes a tubular rotor core 21 and permanent magnets 22 embedded in a plurality of (ten in the present embodiment) slots 23 formed in a circumferential direction of the rotor 2 (around a rotational axis C) inside of the rotor core 21. The plurality of slots 23 are formed inside of the rotor core 21 such that they penetrate the rotor core 21 in a direction of the rotational axis C and are arranged in a circumferential direction of the rotor core 21. In the present embodiment, two permanent magnets 22 are embedded in one slot 23. Since the two permanent magnets 22 are inserted into each slot 23, a plurality of (ten) magnetic-pole sections 22a are formed in the rotor 2. The ten slots 23 are arranged at equal intervals in the circumferential direction of the rotor 2.

Although in the present embodiment, one magnetic-pole section 22a is formed by inserting the two permanent magnets 22 into one slot 23, the present invention is not limited to this. For example, one magnetic-pole section 22a may be formed by inserting one permanent magnet 22 into one slot 23, one magnetic-pole section 22a may be formed by inserting the two permanent magnets 22 into two slots 23, or one magnetic-pole section 22a may be formed by inserting three or more permanent magnets 22 into three or more slots 23.

The permanent magnets 22 have a plate shape. Corner portions of the permanent magnets 22 may be chamfered or rounded. This makes it possible to prevent the permanent magnets 22 from getting broken (fractured), or cracked in manufacturing. As the permanent magnets 22, rare-earth magnets formed using a rare-earth element such as neodymium are used. By using the permanent magnets 22 formed so as to have a high magnetic force using the rare-earth element, a smaller size and a higher output of the rotor 2 can be attained.

In the present embodiment, the permanent magnets 22 are inserted into ten slots 23 in such a manner that surfaces of the permanent magnets 22 facing each other with respect to the rotational axis C, which surfaces face each other, have the same polarity (the permanent magnets 22 facing each other are placed in such a manner that the same polarity faces the stator 1). In other words, the two permanent magnets 22 embedded in the same slot 23 are configured such that their polarities at outer peripheral side face the same direction. The rotor core 21 and the permanent magnets 22 may be secured to each other by a suitable adhesive.

In the motor configured as described above, by changing a direction of a current flowed through the coils 12 of the stator 1, the shaft and the rotor 2 rotate with respect to the stator 1, around the rotational axis C which is the center axis of the shaft.

The rotor core 21 includes hollow portions 24 formed by cutting portions of the rotor core 21 which are between the magnetic-pole sections 22a which are adjacent in the circumferential direction of the rotor core 21 such that portions of circumferential end portions of the permanent magnets 22 are exposed, and extending portions 25 each of which is formed in a position corresponding to the hollow portions 24 and extends radially outward from a center portion 211 of the rotor core 21.

In the rotor, when a d-axis current Id flows in a direction of a d-axis which is a center axis of the magnetic-pole section (permanent magnet constituting one magnetic pole), interlocked magnetic flux φd is generated, while when a q-axis current Iq flows in a direction of a q-axis which is an axis extending through the center between two magnetic-pole sections, interlocked magnetic flux φq is generated. In the SPM motor, there is no distinction between the q-axis and the d-axis, and therefore the interlocked magnetic flux is fixed in any axial direction. On the other hand, in the IPM motor, in general, the interlocked magnetic flux φq associated with the q-axis current Iq is greater than the interlocked magnetic flux φd associated with the d-axis current Id. This is due to the fact that the interlocked magnetic flux φd associated with the q-axis current Id passes through the permanent magnet which is low in permeability, and therefore is smaller than the interlocked magnetic flux φq associated with the q-axis current Iq passing through only a rotator core portion. For this reason, a magnetic resistance of the q-axis (q-axis inductance Lq) is greater than a magnetic resistance of the d-axis (d-axis inductance Ld). That is, a salient-pole ratio ρ=Lq/Ld>1 (ρ=1 in the SPM motor).

In accordance with the rotor 2 of the present embodiment, portions of the rotor core 21 which portions are between the magnetic-pole sections 22a which are formed by the permanent magnets 22, are cut to form hollow portions such that the portions of the circumferential end portions of the permanent magnets 22 are exposed. This makes it possible to prevent a situation in which the magnetic flux leaks through the rotor core portion (bridge portion) between the magnetic-pole sections 22a. In addition, each of the extending portions 25 is formed in a position corresponding to the hollow portions 24 such that the extending portion 25 extends radially outward from the center portion 211 of the rotor core 21. In this structure, by adjusting the permeability of the q-axis (axis between the magnetic-pole sections 22a) with respect to the permeability of the d-axis (center axis of the magnetic-pole section 22a), the reluctance torque can be made smaller than that of the conventional general IPM motor. Therefore, by constructing the motor using the rotor core 21 having the above configuration, a general inverter, a general controller, etc., may be used even when this motor is used as a servo motor in place of the conventional SPM motor. As a result, high reliability and low cost can be achieved.

By suitably adjusting the length of the extending portion 25, the reluctance torque can be adjusted appropriately. Therefore, the reluctance torque can be adjusted appropriately while preventing a leakage of the magnetic flux.

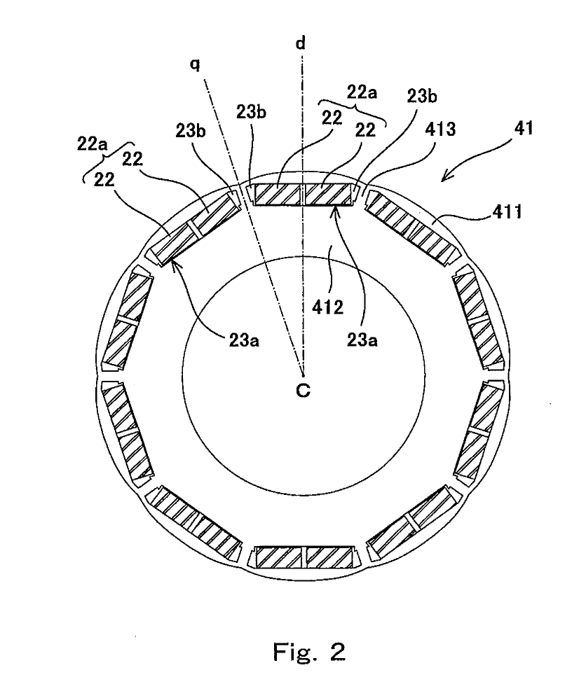

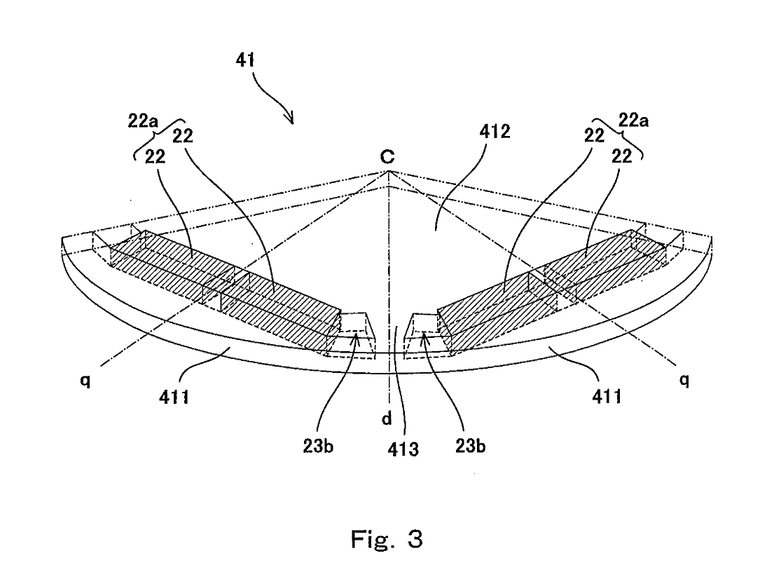

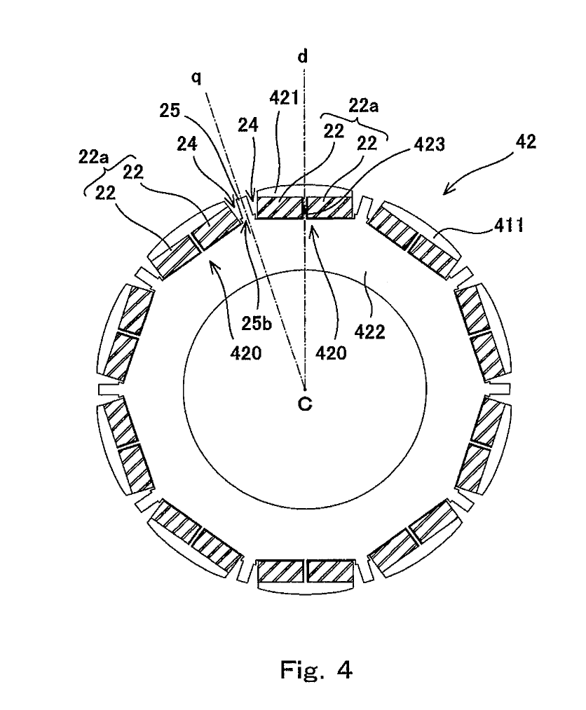

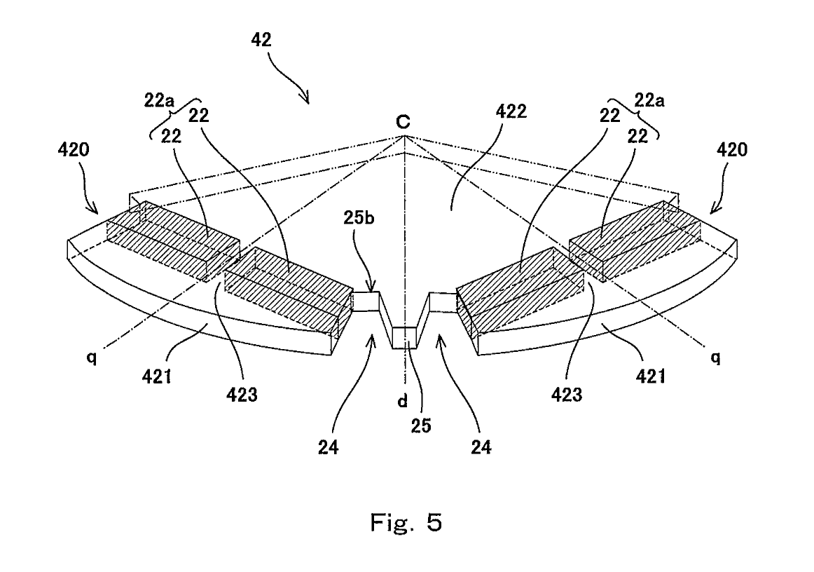

In the present embodiment, the rotor core 21 is constructed by bonding a plurality of plate members (first and second plate members as will be described later) to each other. FIG. 2 is a plan view showing a first plate member constituting the rotor of the motor of FIG. 1. FIG. 3 is a partially enlarged perspective view of the first plate member of FIG. 2. FIG. 4 is a plan view showing a second plate member constituting the rotor of the motor of FIG. 1. FIG. 5 is a partially enlarged perspective view of the second plate member of FIG. 4.

The rotor core 21 is constructed by stacking together at least one first plate member 41 of FIG. 2 and at least one second plate member 42 of FIG. 4.

Firstly, the first plate member 41 will be described. As shown in FIGS. 2 and 3, the first plate member 41 is provided with a plurality of (ten) openings 23a into which the permanent magnets 22 are inserted such that the openings 23 are arranged in the circumferential direction. Each of the openings 23a surrounds one magnetic-pole section 22a formed by inserting the two permanent magnets 22 into this opening 23a. Specifically, the first plate member 41 includes an outer peripheral portion 411 located radially outward relative to the permanent magnets 22, a center portion 412 located radially inward relative to the permanent magnets 22, and a bridge portion 413 which is located between the plurality of magnetic-pole sections 22a (between the openings 23a) and connects the outer peripheral portion 411 and the center portion 412 to each other. The openings 23a are defined by the outer peripheral portion 411, the center portion 412 and the bridge portion 413. Each of the openings 23a surrounds the permanent magnets 22 of the corresponding one of the magnetic-pole sections 22a.

As described above, in the first plate member 41, since the opening 23a surrounds one magnetic-pole section 22a, it becomes possible to prevent a situation in which the permanent magnets 22 inserted into the opening 23a will be scattered due to the rotation.

In the present embodiment, the opening 23a may be configured such that a gap 23b is formed between one of the circumferential both end portions of the magnetic-pole section 22a and the inner wall of the opening 23a. In other words, the bridge section 413 is distant from the permanent magnet 22.

Since the gap 23b is formed between the magnetic-pole section 22a composed of the two permanent magnets 22 and the inner wall of the opening 23a in the rotor core 21, a flux barrier portion can be formed. In other words, since the magnetic resistance in the gap 23b increases, it becomes possible to effectively prevent a leakage of the magnetic flux from the permanent magnets 22 to outside.

Next, the second plate member 42 will be described. As shown in FIGS. 4 and 5, the second plate member 42 includes a plurality of magnet support portions 420 provided in positions corresponding to the openings 23a of the first plate member 41, respectively. Specifically, each of the magnet support portions 420 includes in a state in which the permanent magnets 22 are inserted, an outer peripheral portion 421 located radially outward relative to the permanent magnets 22, a center portion 422 located radially inward relative to the permanent magnets 22, and a connecting portion 423 provided in a position corresponding to a circumferential center region of the opening 23a of the first plate member 41 such that the connecting portion 423 connects the outer peripheral portion 421 and the center portion 422 to each other.

The hollow portion 24 is formed in a position corresponding to each of the circumferential both end portions of the opening 23a (first plate member 41) such that the outer peripheral portion 421 of the second plate member 42 and the center portion 422 of the second plate member 42 are apart from each other. In other words, the second plate member 42 is configured such that the circumferential both end portions of each magnetic-pole section 22a are exposed to outside. The permanent magnets 22 constituting each magnetic-pole section 22a are separated as two magnets such that the outer peripheral portion 421 and the center portion 422 are connected to each other via the connecting portion 423 in the circumferential center portion of each magnetic-pole section 22a (two permanent magnets 22 constitute one magnetic-pole section 22a). The connecting portion 423 extends in the d-axis direction.

The extending portion 25 may be formed between adjacent magnet support portions 420 formed in the second plate member 42 such that the extending portion 25 extends radially of the rotor core 21 from the center portion 422. That is, the extending portion 25 extends in the q-axis direction.

By stacking together the first plate member 41 and the second plate member 42 configured as described above, the rotor core 21 is constructed in such a manner that the center portion 211 has a structure in which the center portion 412 of the first plate member 41 and the center portion 422 of the second plate member 42 are stacked together, and extending portion 25 of the second plate member 42 extends radially outward from the center portion 211.

With the above described configuration of the second plate member 42, it becomes possible to form the hollow portions 24 and the extending portions 25 which are able to optimally adjust the reluctance torque while preventing a leakage of the magnetic flux. Therefore, by constructing the rotor core 21 by stacking together the first plate member 41 and the second plate member 42, it becomes possible to easily construct the IPM motor which has high reliability, is manufactured at low cost, and is applicable to a general inverter, a general controller, etc.

The tip end of the extending portion 25 is located inward relative to a turning circle of the outer peripheral portion 421. This can effectively reduce the reluctance torque.

In the present embodiment, the extending portion 25 has a structure in which a circumferential width of a base end portion 25b thereof is greater than a circumferential width of a tip end portion thereof. The base end portion 25b of the extending portion 25 serves as a positioning portion for positioning the permanent magnet 22 in the circumferential direction. In other words, the circumferential displacement of the permanent magnet 22 between the base end portion 25b of the extending portion 25 and the connecting portion 423 is restricted. The shape of the extending portion 25 is not limited to the shape of the present embodiment so long as the reluctance torque can be reduced.

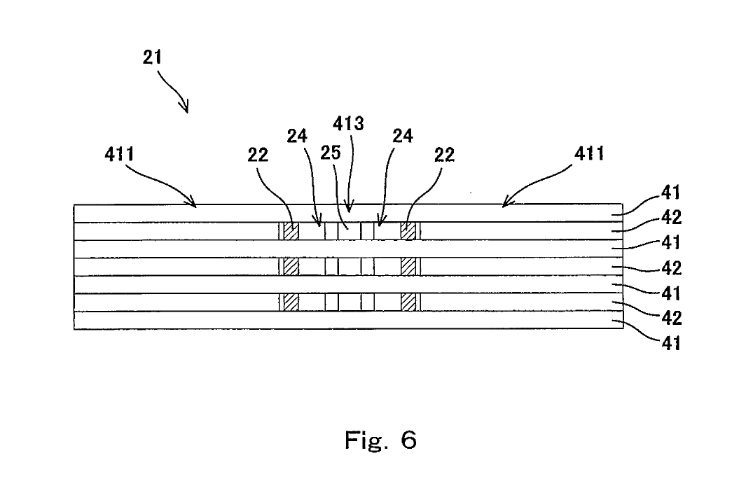

In the present embodiment, the rotor core 21 is constructed in such a manner that one first plate member 41 and one second plate member 42 as described above are alternately stacked together. FIG. 6 is a side view of the rotor core of the motor of FIG. 1, when viewed from the q-axis direction. As shown in FIG. 6, the extending portion 25 of the second plate member 42 is vertically sandwiched between the bridge portions 413 of the first plate members 41. Thereby, the outer peripheral portion 421 of the second plate member 42 and the center portion 422 of the second plate member 42 are connected to each other via the first plate member 41 as well as the connecting portion 423. Therefore, the whole rotor core 21 can enhance its strength, and it becomes possible to more effectively prevent the permanent magnets 22 (and outer peripheral portion 421) from being scattered due to the rotation.

The rotor core 21 may be constructed in such a manner a set of a plurality of first plate members 41 and a set of a plurality of second plate members 42 are alternately stacked together. Or, the number of first plate members 41 to be stacked may be made different from the number of second plate members 42 to be stacked. Or, at least one second plate member 42 may be bonded to upper and lower sides of a structure in which one or a plurality of second plate members 42 is/are stacked.

### EXAMPLE 1

Hereinafter, a description will be given of a result of analysis of the torque constant and the salient-pole ratio in a case where the length of the extending portion 25 of the rotor described in the above embodiment is changed, in comparison with a torque constant and a salient-pole ratio of a general IPM motor and a torque constant and a salient-pole ratio of a general SPM motor. In Example described below, as an indicator of the length of the extending portion 25, used is a ratio (hereinafter will be referred to as extension ratio) of the length (distance between the rotational axis C and the tip end of the extending portion 25) of the extending portion 25 with respect to the outer diameter (radius of the turning circle) of the rotor 2. Specifically, the values of the torque constant, etc., in five lengths in the extension ratio of 0.888 to 0.985 are plotted in a graphical representation. Note that when the extension ratio is 0.888, the extending portion 25 is only the length of the base end portion 25b in FIG. 4.

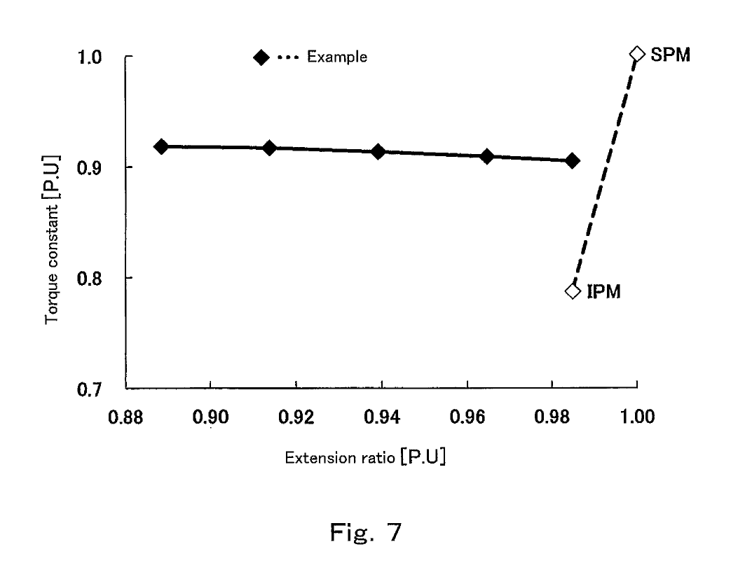

FIG. 7 is a graph showing a change in the torque constant corresponding to the length of the extending portion in the motor including the rotor in Example of the present invention, in comparison with the torque constant of the general IPM motor and the torque constant of the general SPM motor. As can be seen from FIG. 7, the extending portion 25 of any length could result in a torque constant which was higher than that in the conventional general IPM motor, although the torque constant was lower than that in the conventional general SPM motor. Therefore, it was revealed that even when the extending portion 25 is formed, the leakage of the magnetic flux through the rotor core portion (bridge portion) between the magnetic-pole sections 22a can be prevented by the hollow portion 24, as compared to the conventional general IPM motor.

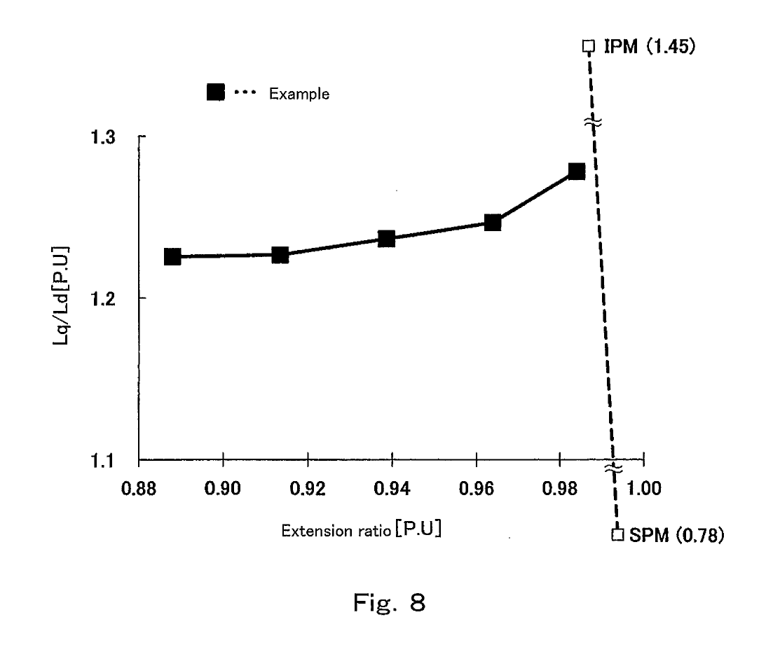

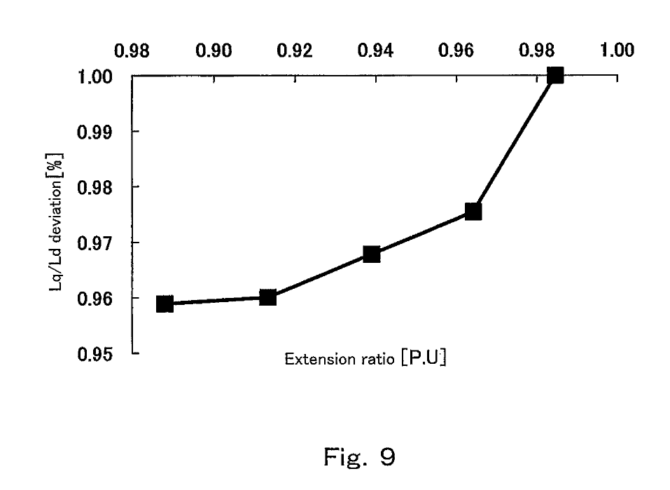

FIG. 8 is a graph showing a change in the salient-pole ratio (Lq/Ld) corresponding to the length of the extending portion in the motor including the rotor in Example of the present invention, in comparison with the salient-pole ratio of the general IPM motor and the salient-pole ratio of the general SPM motor. FIG. 9 is a graph showing deviations of the salient-pole ratios from the salient-pole ratio in a case where the extension ratio is 0.985 in the graph of Example of FIG. 8.

As described above, because of an increase in the q-axis magnetic flux, the q-axis inductance Lq of the general IPM motor is greater than that in the general SPM motor. Therefore, as shown in FIG. 8, the salient-pole ratio ρ=Lq/Ld in the conventional general IPM motor is greater than that in the general SPM motor. In addition to this, in the configuration of the present example, since the q-axis magnetic flux decreases because of the hollow portion 24. Therefore, in the case of the extending portion 25 of any length, the salient-pole ratio ρ is lower in the present example than in the conventional general IPM motor. In addition, as can be seen from FIGS. 8 and 9, the salient-pole ratio ρ changes with a change in the length of the extending portion 25. As can be seen from FIG. 9, a changing magnitude of the salient-pole ratio ρ in the present example is about 4%. From this, according to the present example, it was revealed that the reluctance torque can be adjusted appropriately by suitably adjusting the length of the extending portion 25.

Thus far, the embodiment of the present invention has been described. The present invention is not limited to the above embodiment and the embodiment can be improved, changed or modified in various ways without departing from a spirit of the invention. Although in the above embodiment, for example, the rotor includes ten magnetic-pole sections 22a, the rotor of the present invention may include magnetic-pole sections 22a which are more than ten or less than ten so long as the magnetic-pole sections 22a have the above described configuration.

Numerous modifications and alternative embodiments of the invention will be apparent to those skilled in the art in view of the foregoing description. Accordingly, the description is to be construed as illustrative only, and is provided for the purpose of teaching those skilled in the art the best mode of carrying out the invention. The details of the structure and/or function may be varied substantially without departing from the spirit of the invention and all modifications which come within the scope of the appended claims are reserved.

### INDUSTRIAL APPLICABILITY

A rotor of a motor and a motor comprising the rotor of the present invention are effectively used to adjust reluctance torque appropriately while preventing a leakage of magnetic flux.

### REFERENCE SIGNS LIST

1 stator
2 rotor
3 hole
11 stator core
11a tubular portion
11b tooth
12 coil
21 rotor core
22 permanent magnet
22a magnetic-pole section
23 slot
23a opening
23b gap
24 hollow portion
25 extending portion
25b base end portion
41 first plate member
42 second plate member
211 center portion of rotor core
411 outer peripheral portion of first plate member
412 center portion of first plate member
413 bridge portion
420 magnet support portion
421 outer peripheral portion of second plate member
422 center portion of second plate member
423 connecting portion
C rotational axis

1. A rotor of a motor comprising:
a plurality of magnetic-pole sections including:
a plurality of slots which are formed inside of a rotor core such that the slots penetrate the rotor core in a rotational axis direction and are arranged in a circumferential direction of the rotor core; and
permanent magnets, at least one of which is inserted into each of the plurality of slots;
wherein each of the magnetic-pole sections is formed to correspond to the at least one permanent magnet; and
wherein the rotor core includes hollow portions formed by cutting portions of the rotor core which portions are between the magnetic-pole sections which are adjacent in the circumferential direction of the rotor core and are different in polarity such that portions of circumferential end portions of the permanent magnets are exposed, and extending portions each of which is formed in a position corresponding to the hollow portions and extends radially outward from a center portion of the rotor core.

2. The rotor of the motor according to claim 1,
wherein the rotor core is configured to include at least one first plate member and at least one second plate member which are stacked together;
wherein the first plate member is provided with a plurality of openings into which the permanent magnets are inserted such that the openings are arranged in the circumferential direction of the rotor core, and each of the openings surrounds one magnetic-pole section formed by inserting two permanent magnets into the opening;
wherein the second plate member includes a plurality of magnet support portions provided in positions corresponding to the openings of the first plate member, respectively;
wherein each of the magnet support portions includes in a state in which the permanent magnets are inserted into the slots, an outer peripheral portion located radially outward relative to the permanent magnets, the center portion located radially inward relative to the permanent magnets, and a connecting portion provided in a position corresponding to a circumferential center region of the opening of the first plate member such that the connecting portion connects the outer peripheral portion and the center portion to each other;
wherein the hollow portions are formed in positions corresponding to circumferential both end portions of the opening such that the outer peripheral portion of the second plate member and the center portion of the second plate member are apart from each other, in a state in which the permanent magnets are inserted; and
wherein each of the extending portions is formed between adjacent magnet support portions formed in the second plate member such that the extending portion extends radially of the rotor core from the center portion.

3. The rotor of the motor according to claim 1,
wherein a tip end of each of the extending portions is located inward relative to a turning circle of the outer peripheral portion.

4. The rotor of the motor according to claim 2,
wherein the rotor core is configured in such a manner that one first plate member and one second plate member are alternately stacked together, or a set of a plurality of first plate members and a set of a plurality of second plate members are alternately stacked together.

5. The rotor of the motor according to claim 2,
wherein each of the openings is configured such that a gap is formed between each of the circumferential both end portions of each of the permanent magnets and an inner wall of the opening, in a state in which the permanent magnets are inserted into the slots.

6. A motor comprising the rotor of the motor according to claim 1.
